(19) United States
(12) Patent Application Publication
(10) Pub. No.: US 2018/0320641 A1
(43) Pub. Date: Nov. 8, 2018

(54) FUEL REFORMING SYSTEM

(71) Applicants: Hyundai Motor Company, Seoul (KR); Kia Motors Corporation, Seoul (KR)

(72) Inventors: Hong Kil BAEK, Seoul (KR); Seung Woo Lee, Seoul (KR); Tae Won Lee, Incheon (KR)

(73) Assignees: Hyundai Motor Company, Seoul (KR); Kia Motors Corporation, Seoul (KR)

(21) Appl. No.: 15/719,355

(22) Filed: Sep. 28, 2017

(30) Foreign Application Priority Data
May 8, 2017 (KR) 10-2017-0057258

(51) Int. Cl. F02M 26/36; F01P 7/16; F02M 53/04; F02M 26/06; F02M 26/28; F02M 25/12

(52) U.S. Cl. CPC F02M 26/36; F01P 7/16; F02M 25/12; F02M 26/06; F02M 26/28; F02M 53/043

(57) ABSTRACT

A fuel reforming system may include an engine combusting reformed gas to generate mechanical power; an intake line connected to the engine to supply reformed gas and air to the engine; an exhaust line connected to the engine to circulate exhaust gas exhausted from the engine; a fuel reformer provided at an exhaust gas recirculation (EGR) line diverging from the exhaust line, mixing the exhaust gas passing through the EGR line with the fuel and reforming the fuel mixed in the EGR gas; a water temperature controller (WTC) provided at the engine to control coolant cooling the engine; and a radiator radiating a portion of heat generated from the engine to atmosphere through the coolant.

### CROSS-REFERENCE TO RELATED APPLICATION

The present application claims priority to Korean Patent Application No. 10-2017-0057258 filed on May 8, 2017, the entire contents of which is incorporated herein for all purposes by this reference.

### BACKGROUND OF THE INVENTION

### Field of the Invention

The present invention relates to a fuel reforming system. More particularly, the present invention relates to a fuel reforming system which includes coolant passage cooling an engine and a fuel reformer simultaneously.

### Description of Related Art

Hydrogen which is a material having most light and simple structure on earth has physical and chemical characteristic of about 6 times of laminar flame velocity and about three times of lower heating value compared with gasoline. Accordingly, during combusting by properly mixing gasoline and hydrogen, combustion speed and combustion stability may be increased to improve thermal efficiency by expanding lean boundary or increasing supply amount of exhaust gas recirculation.

Meanwhile, a fuel reformer is a system generating hydrogen. The hydrogen is generated by reacting separate gasoline fuel supplied to the reformer with a catalyst in the reformer using thermal energy of high temperature exhaust gas exhausted from an engine.

By the way, in a certain condition that the exhaust gas temperature is high, cooling the fuel reformer is necessary to prevent an injector in the fuel reformer from being overheated. For this, in a conventional technology, structure of the fuel reforming system is complicated and system cost and weight increases.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a fuel reforming system including one coolant passage circulating an engine and a fuel reformer and structure of coolant supply.

A fuel reforming system according to an exemplary embodiment of the present invention includes an engine combusting reformed gas to generate mechanical power; an intake line connected to the engine to supply reformed gas and air to the engine; an exhaust line connected to the engine to circulate exhaust gas exhausted from the engine; a fuel reformer provided at an exhaust gas recirculation (EGR) line diverging from the exhaust line, mixing the exhaust gas passing through the EGR line with the fuel and reforming the fuel mixed in the EGR gas; a water temperature controller (WTC) provided at the engine to control coolant cooling the engine; and a radiator radiating a portion of heat generated from the engine to atmosphere through the coolant, wherein the fuel reformer includes a housing; a mixing portion provided in the housing and being a space mixing the fuel supplied from outside and the EGR gas; a fuel injector provided at a side of the housing and supplying the fuel to the mixing portion; and a coolant entrance and a coolant exit provided around the fuel injector and which the coolant inflows into and outflows from the internal to the fuel reformer.

The water temperature controller may be provided at a side of the engine exit.

The fuel reformer may further include an EGR pipe provided at a side of the mixing portion and through which the EGR gas inflows; and a reforming catalyst portion provided at the other side of the mixing portion and reforming the fuel and EGR gas mixed in the mixing portion.

The coolant passage may be provided to connect the engine exit, the coolant entrance, the coolant exit, the radiator, and the engine entrance in series.

A fuel reforming system according to an exemplary embodiment of the present invention may further include a compressor connected to the intake line and compressing and supplying the reformed gas and air to the engine; and a turbine connected to the exhaust line and rotating by the exhaust gas to generate power.

At the EGR line, an EGR cooler cooling the reformed gas and an EGR valve disposed at a rear end portion of the EGR cooler and adjusting flow rate of the reformed gas may be disposed.

The reformer may be disposed at a front portion of the EGR cooler in the EGR line.

According to an exemplary embodiment of the present invention, malfunction of the fuel reforming system by overheating of the fuel injector may be prevented by supplying coolant to the fuel reformer in a high speed/high torque driving condition which gas temperature is high.

Also, the system structure may be simplified and the system cost and weight may be reduced since separate coolant supplying device for a fuel reformer is not necessary by cooling the fuel reformer by use of coolant in the engine.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic view illustrating a fuel reforming system according to an exemplary embodiment of the present invention.

FIG. 2 is a schematic view illustrating a fuel reformer according to an exemplary embodiment of the present invention.

FIG. 3 is a perspective view illustrating a fuel reformer according to an exemplary embodiment of the present invention.

It may be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, exemplary embodiments of the present application will be described more fully with reference to the accompanying drawings, in which exemplary embodiments of the invention are shown. As those skilled in the art would realize, the described embodiments may be modified in various different ways, all without departing from the spirit or scope of the present invention.

Further, in exemplary embodiments, since like reference numerals designate like elements having the same configuration, various exemplary embodiments is representatively described, and in other exemplary embodiments, only configurations different from the various exemplary embodiments will be described.

The drawings are schematic, and are not illustrated in accordance with a scale. Relative dimensions and ratios of portions in the drawings are illustrated to be exaggerated or reduced in size for clarity and convenience, and the dimensions are just exemplified and are not limiting. In addition, same structures, elements, or components illustrated in two or more drawings use same reference numerals for showing similar features. It will be understood that when an element such as a layer, film, region, or substrate is referred to as being “on” another element, it can be directly on the other element or intervening elements may also be present.

The exemplary embodiment of the present invention shows an exemplary embodiment of the present invention in detail. As a result, various modifications of the drawings will be expected. Therefore, the exemplary embodiment is not limited to a specific aspect of the illustrated region, and for example, includes modifications of an aspect by manufacturing.

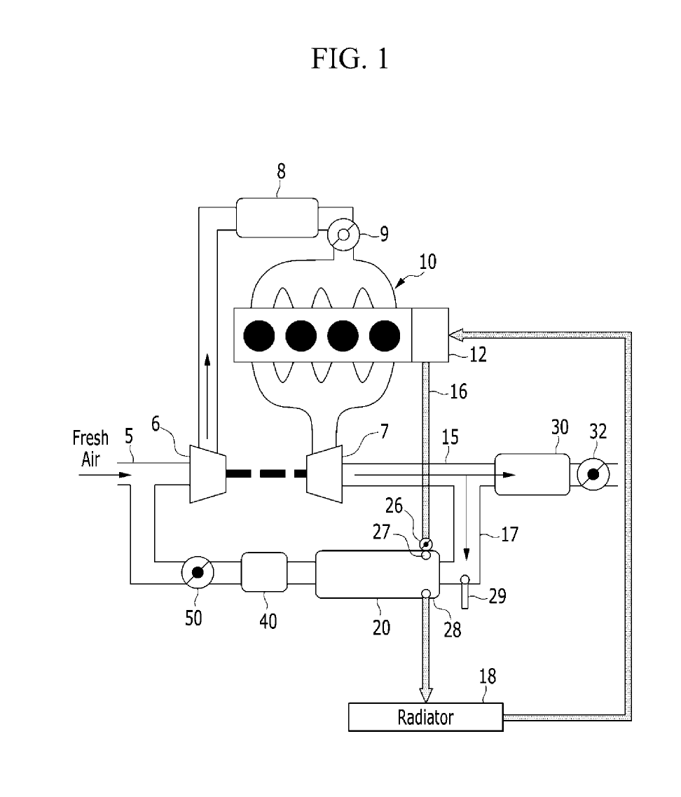

Now, a fuel reforming system according to an exemplary embodiment of the present invention will be described with reference to FIG. 1.

FIG. 1 is a schematic view illustrating a fuel reforming system according to an exemplary embodiment of the present invention.

Referring to FIG. 1, a fuel reforming system 100 includes an engine 10, an intake line 5, an exhaust line 15, a fuel reformer 20, a water temperature controller (WTC) 12 and a radiator 18.

The engine 10 burns air-fuel mixture in which fuel and air are mixed to convert chemical energy into mechanical energy. The engine 10 is connected to an intake manifold to receive the air in a combustion chamber, and is connected to an exhaust manifold such that exhaust gas generated in combustion process is gathered in the exhaust manifold and is exhausted to the external. An injector is mounted in the combustion chamber to inject the fuel into the combustion chamber.

The intake line 5 is connected to entrance of the engine 10 to supply reformed gas and air to the engine 10, and the exhaust line 15 is connected to exit of the engine 10 to circulate exhaust gas expelled from the engine 10.

A portion of the exhaust gas expelled from the engine is supplied to the engine 10 through the EGR line 17. Also, the EGR line 17 is connected to the intake manifold of the engine 10 so that combustion temperature is controlled by mixing a portion of the exhaust gas with air. This combust temperature control is conducted by adjusting exhaust gas amount supplied to the intake manifold. Accordingly, EGR valve 50 adjusting flow rate of the reformed gas may be disposed at the EGR line 17.

An exhaust gas recirculation system realized by the EGR line 17 supplies a portion of the exhaust gas to the intake system and inflows to combustion chamber when exhaust amount of the nitrogen oxide needs to be reduced according to driving condition. As such, the exhaust gas that is inert gas which volume is not changed depresses density of the air-fuel mixture and flame transmitting speed is reduced during combustion of the fuel. Therefore, combustion velocity of the fuel is reduced and raise of the combustion temperature is reduced to depress generation of the nitrogen oxide.

The fuel reformer 20 is disposed at the EGR line 17 diverging from the exhaust line 15 and mixes the exhaust gas inflowing from the EGR line 17 with fuel to reform the fuel mixed with the exhaust gas.

An EGR cooler 40 cooling reformed gas passing through the engine 10 and the fuel reformer 20 may be provided at the EGR line 17. An EGR cooler 25 may be provided at a rear end portion of the fuel reformer 20 and integrally provided with the fuel reformer 20.

Meanwhile, the water temperature controller (WTC) 12 is provided at the engine 10 and controls temperature of coolant cooling the engine 10. The water temperature controller 12 may be provided at a side of the engine exit.

The radiator 18 is a device radiating a portion of heat generated from the internal combustion engine to atmosphere through the coolant. The radiator 18 transmits high temperature coolant into a thin pipe and passes air to space between the pipe by a cooling fan to cool the coolant.

The coolant passage 16 may be provided to connect the engine 10 exit, the fuel reformer 20, the radiator 18 and the engine 10 entrance in series, and the coolant may be circulated through the engine 10, the water temperature controller 12, the fuel reformer 20, and the radiator 18.

Meanwhile, the fuel reforming system 100 according to an exemplary embodiment of the present invention may further include a compressor 6 connected to the intake line 5 and compresses the reformed gas and air to supply to the engine 10, and a turbine 7 connected to the exhaust line 15 and rotates by the exhaust gas to generate power.

Also, the reforming system may include an intercooler 8 connected to the compressor 6 and cooling air and reformed gas flowed into the intake line 5 of the engine 10 again, and a throttle valve 9 adjusting flow rate of the air and reformed gas.

Also, the fuel reforming system 100 according to an exemplary embodiment of the present invention may further include a catalyst 30 disposed at the exhaust line 15 of rear portion of the EGR line 17 and purifying the nitrogen oxide included in the exhaust gas.

An exhaust pressure control valve 32 adjusting flow rate of the exhaust gas may be provided at a rear end portion of the catalyst 30 in the exhaust line 15.

Meanwhile, at the EGR line 17, an EGR valve 50 provided at a rear end portion of the EGR cooler 27 and adjusting flow rate of the reformed gas may be disposed.

Meanwhile, the fuel reforming system according to an exemplary embodiment of the present invention may further include a temperature detector 29 provided at the EGR line 17 of a front end portion of the fuel reformer 20 and measuring exhaust gas temperature of the front end portion of the fuel reformer 20. Also, a coolant supply control valve 26 may be disposed at the coolant entrance 27 to supply to the internal to the fuel reformer 20 or not according to engine driving condition and exhaust gas temperature.

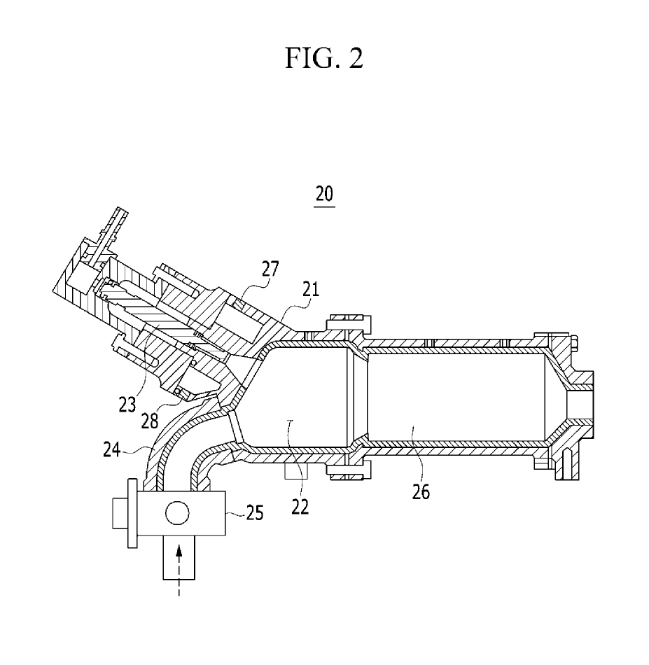

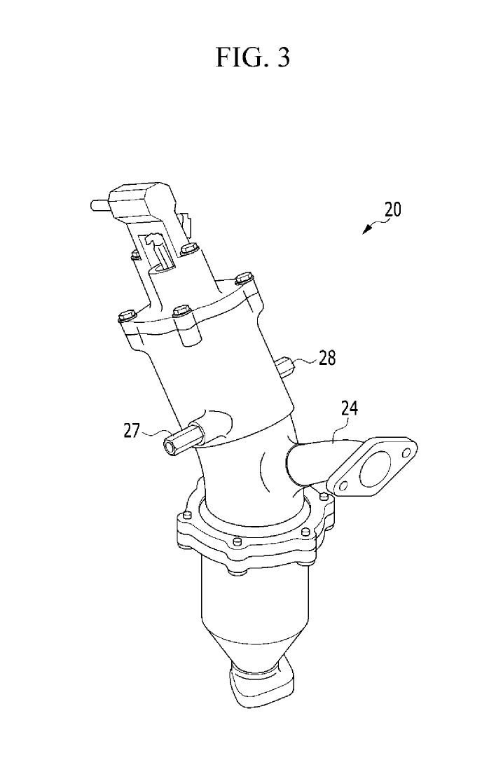

FIG. 2 is a schematic view illustrating a fuel reformer according to an exemplary embodiment of the present invention, and FIG. 3 is a perspective view illustrating a fuel reformer according to an exemplary embodiment of the present invention.

Referring to FIG. 2 and FIG. 3, the fuel reformer 20 may include a housing 21, a mixing portion 22 being a space mixing the fuel supplied from outside and the EGR gas, a fuel injector 23 supplying the fuel to the mixing portion 22, an EGR pipe 24 in which the EGR gas flows, a flow rate control valve 25 adjusting amount of the EGR gas passing through the EGR pipe 24, and a reforming catalyst portion 26 reforming the fuel and EGR gas mixed in the mixing portion 22. Also, a coolant entrance 27 and a coolant exit 28 which coolant inflows into and outflows from may be provided around the fuel injector. Overheated fuel injector 23 may be cooled by inflowing and outflowing the coolant through the coolant entrance 27 and the coolant exit 28.

The mixing portion 22 is provided in the housing 21, and is a space mixing the fuel supplied from outside by the fuel injector 23 and EGR gas flowed in from the EGR pipe 24.

The fuel injector 23 is disposed at one side of the housing 21, and the flow rate control valve 25 is disposed at the EGR pipe 24. The flow rate control valve 25 adjusts amount of the EGR gas passing through the EGR pipe 24. The reforming catalyst portion 26 is provided at an opposite side to side on which the EGR pipe 24 is located, and reforms the fuel and EGR gas mixed in the mixing portion 22.

According to an exemplary embodiment of the present invention, malfunction of the fuel reforming system by overheating of the fuel injector may be prevented by supplying coolant to the fuel reformer in a high speed/high torque driving condition which gas temperature is high.

Also, the system structure may be simplified and the system cost and weight may be reduced since separate coolant supplying device for a fuel reformer is not necessary by cooling the fuel reformer by use of coolant in the engine.

For convenience in explanation and accurate definition in the appended claims, the terms “upper”, “lower”, “internal”, “outer”, “up”, “down”, “upper”, “lower”, “upwards”, “downwards”, “front”, “rear”, “back”, “inside”, “outside”, “inwardly”, “outwardly”, “internal”, “external”, “internal”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A fuel reforming system, comprising:
an engine combusting reformed gas to generate mechanical power;
an intake line connected to the engine to supply the reformed gas and an air to the engine;
an exhaust line connected to the engine to circulate exhaust gas expelled from the engine;
a fuel reformer provided at an exhaust gas recirculation (EGR) line diverging from the exhaust line, mixing the exhaust gas passing through the EGR line with a fuel and reforming the fuel mixed in EGR gas;
a water temperature controller (WTC) provided at the engine to control coolant cooling the engine; and
a radiator radiating a portion of heat generated from the engine to atmosphere through the coolant,
wherein the fuel reformer includes,
a housing;
a mixing portion provided in the housing and being a space mixing the fuel supplied from outside and the EGR gas;
a fuel injector provided at a side of the housing and supplying the fuel to the mixing portion; and
a coolant entrance and a coolant exit provided around the fuel injector and which the coolant inflows into and outflows from an internal to the fuel reformer.

2. The fuel reforming system of claim 1, wherein the water temperature controller is provided at a side of an engine exit.

3. The fuel reforming system of claim 1, wherein the fuel reformer further includes:
an EGR pipe provided at a first side of the mixing portion and through which the EGR gas inflows; and
a reforming catalyst portion provided at a second side of the mixing portion and reforming the fuel and the EGR gas mixed in the mixing portion.

4. The fuel reforming system of claim 1, wherein a coolant passage is provided to connect an engine exit, the coolant entrance, the coolant exit, the radiator, and an engine entrance in series.

5. The fuel reforming system of claim 1, further including:
a compressor connected to the intake line and compressing and supplying the reformed gas and the air to the engine; and
a turbine connected to the exhaust line and rotating by the exhaust gas to generate power.

6. The fuel reforming system of claim 1, wherein
at the EGR line, an EGR cooler cooling the reformed gas and an EGR valve disposed at a rear end portion of the EGR cooler and adjusting a flow rate of the reformed gas are disposed.

7. The fuel reforming system of claim 6, wherein the fuel reformer is disposed at a front portion of the EGR cooler in the EGR line.
